(19) United States
(12) Patent Application Publication
(10) Pub. No.: US 2024/0294390 A1
(43) Pub. Date: Sep. 5, 2024

(54) AGENT FOR THE STABILISATION OF LIME MILK

(71) Applicant: COATEX, Genay (FR)

(72) Inventors: Christian JACQUEMET, Lyon (FR); Laurie PARRENIN, Villeneuve (FR); Jean-marc SUAU, Lucenay (FR)

(73) Assignee: COATEX, Genay (FR)

(21) Appl. No.: 18/569,306

(22) PCT Filed: Jun. 27, 2022
(86) PCT No.: PCT/FR2022/000061

§ 371 Date: Dec. 12, 2023

(30) Foreign Application Priority Data
Jun. 28, 2021 (FR) FR2106936

(51) Int. Cl. C01F 11/02; C02F 1/66; C08F 290/06; C08K 3/22; C08K 5/1545

(52) U.S. Cl. CPC C01F 11/02; C02F 1/66; C08F 290/062; C08K 3/22; C08K 5/1545; C01P 2006/22; C08K 2003/2206

(57) ABSTRACT

An agent for stabilizing lime milk may combine a specific polymer and one or more osidic, polyol, or acid derivatives. Methods may preparing the agent or prepare lime milk stabilized with the agent. Such a stabilized lime milk can be used to control the pH of a composition, which composition can then be used in a variety of fields. Such a lime milk stabilized with the agent can be used to treat acid effluents or acid fumes. A powder formulation or a paste formulation may be used for preparing stabilized lime milk.

The invention relates to an agent for stabilising lime milk. This agent combines a particular polymer and one or more osidic, polyol or acid derivatives. The invention also provides a method for preparing this agent as well as a method for preparing lime milk stabilised by means of this agent. According to the invention, stabilised lime milk can be used to control the pH of a composition which can then be used in many fields. In particular lime milk stabilised by means of the agent according to the invention can be used to treat acid effluents or acid fumes. The invention also provides a powder formulation or a paste formulation for preparing a stabilised lime milk.

Lime milk consists essentially of two ingredients which are water and particles of lime, or calcium dihydroxide (Ca(OH)₂), suspended in water. Other ingredients can be used to aid in the preparation, storage, or use of lime milk. In fact, lime milk must have numerous properties when it is prepared, stored or used. In particular, lime milk must have a high lime concentration yet be stable in order to ensure that the lime particles do not settle. The size of the lime particles and the rheology of the lime milk must also be very well controlled. When used in an acid environment, the neutralizing properties of lime milk are also important. This is because lime milk is generally used in industrial applications, in which it must be able to act quickly.

Document WO 2020094607 relates to the preparation of a lime milk with a particular particle size. This lime milk comprises a comb polymer and a carbohydrate. Document WO 2006050567 discloses an aqueous suspension of low viscosity hydrated lime. This suspension also combines a polycarboxylate dispersant and a carbohydrate compound. Document WO 2007110401 also relates to the use of carbohydrates to stabilise the viscosity of lime milk. Document WO 2014076436 discloses the preparation of lime milk in the presence of a (meth)acrylic polymer by high shear dispersion.

One or more additives are therefore generally used when preparing or using lime milk. In particular, various types of dispersing agents can be present in lime milk. However, the known additives do not always make it possible to provide an effective solution to the problems encountered in the preparation, storage or use of lime milk. There is therefore a need for improved means of preparing lime milk.

The invention makes it possible to provide a solution to all or part of the problems of the additives for preparing, storing or using lime milk. Thus, the invention provides an agent A for controlling the stability of lime milk comprising:
*at least one polymer P prepared by a polymerisation reaction
a1. of at least one anionic monomer (a1) chosen among acrylic acid, methacrylic acid, an acrylic acid salt, a methacrylic acid salt and combinations thereof,
a2. of at least one monomer (a2) of formula I:

L¹-(EO)ₙ—(PO)ₚ—R¹ (I)
wherein:
   L¹ represents a group comprising a group chosen among acrylate, methacrylate, acrylurethane, methacrylurethane, allyloxy, methallyloxy, 3-isopentenyloxy and combinations thereof,
   R¹ represents H or a methyl group,
   EO represents an oxyethylene group,
   PO represents an oxypropylene group,
   n represents a number greater than 55 and less than 300,
   p represents 0 or a number greater than 1 and less than 150, p is less than n and the sum
n+p is greater than 100 and less than 300,
*at least one derivative S chosen among:
   an ose S1 comprising from 3 to 8 carbon atoms;
   an ose oligomer or polyholoside S2 comprising from 2 to 10 ose units;
   a polyol S3 comprising at least three alcohol (OH) groups;
   a hydroxylated carboxylic acid S4 or one of its salts.

Within agent A, the amounts of polymer P and of derivative S can vary relatively substantially and reasonably. Preferably, agent A according to the invention is such that the ratio of the amounts by dry weight of polymer P and of derivative S range from 0.03 to 20, more preferentially from 0.1 to 15 or from 0.3 to 10 or from 0.5 to 5.

Preferably according to the invention, the polymer P has a molecular mass by weight Mw measured by size exclusion chromatography (SEC) ranging from 100,000 g/mol to 500,000 g/mol or from 200,000 g/mol to 500,000 g/mol. More preferably, the molecular mass by weight Mw, measured by SEC, ranges from 200,000 g/mol to 400,000 g/mol or from 150,000 g/mol to 400,000 g/mol. Also preferably, the polymer P has a polymolecularity index measured by SEC ranging from 1.2 to 4, more preferentially ranging from 1.2 to 3.5.

According to the invention, the molecular weight of the polymer P is determined by size exclusion chromatography (SEC). This technique uses a Waters liquid chromatography instrument equipped with two detectors. One combines light scattering at a 90° angle with viscometry measured by a Viscotek Malvern detector viscometer. The other is a Waters refractive index detector. This liquid chromatography instrument is equipped with size exclusion columns chosen in order to separate the various molecular weights of the polymers studied. The liquid elution phase is an aqueous phase containing 1% of KNO₃. In a first step, the polymer P solution is diluted to 0.9% dry in the SEC eluent, which is a 1% solution of KNO₃. Next, the solution is filtered through a 0.2 μm filter. 100 μL are then injected into the chromatography instrument (eluent: a 1% solution of KNO₃). The liquid chromatography instrument has an isocratic pump (Waters 515), the flow rate of which is set to 0.8 mL/min. The chromatography instrument also comprises an oven comprising the following system of columns in series: a Waters Ultrahydrogel Column Guard precolumn (6 cm in length and 40 mm in inner diameter), a Waters Ultrahydrogel straight column (30 cm in length and 7.8 mm in inner diameter) and two Ultrahydrogel 120 A columns (30 cm in length and 7.8 mm in inner diameter). The detection system consists of a Waters 410 RI refractometric detector and of a Malvern 270 Dual Detector viscometer and 90° light scattering detector. The oven is brought to a temperature of 55° C. and the refractometer is brought to a temperature of 45° C. The chromatography instrument is calibrated with a Malvern PolyCal single poly-ethoxylate standard (19,000 g/mol).

According to the invention, the polymer P is prepared from monomers a1 and a2. Preferably, monomer a1 is chosen among acrylic acid, methacrylic acid, and combinations thereof. Also preferably, monomer a2 is a compound of formula I wherein L¹ represents a group comprising a group chosen among acrylate and methacrylate. Also preferably, monomer a2 is a compound of formula I wherein R¹ represents H or a compound of formula I wherein R¹ represents a methyl group. Also preferably, monomer a2 is a compound of formula I wherein n represents a number ranging from 80 to 150 or a compound of formula I wherein p represents a number greater than 1 and less than or equal to 20 or monomer a2 is a compound of formula I wherein n represents a number greater than 80 and less than or equal to 150 and p represents a number greater than 1 and less than or equal to 20. More preferably, monomer a2 is a compound of formula I wherein n represents a number greater than 55 and less than 150 and p represents 0. Also more preferably, monomer a2 is a compound of formula I wherein n represents a number greater than 80 and less than or equal to 150 and p represents a number greater than 1 and less than or equal to 20. According to the invention and unless otherwise indicated, a lower value or a higher value does not include the corresponding limit. Particularly preferably, monomer a2 is a compound of formula I wherein the sum n+p represents a number ranging from 101 to 300 or a number ranging from 102 to 300 or a number ranging from 105 to 300 or a number ranging from 110 to 300.

When preparing the polymer P, the amounts of monomers a1 and a2 can vary. Preferably according to the invention, the polymer P is prepared by a polymerisation reaction that uses from 60 to 90 mol % of monomer a1 and from 10 to 40 mol % of monomer a2, relative to the total amount of monomers.

Essentially according to the invention, the polymer P is prepared from monomers a1 and a2. Nevertheless, other monomers can be used in its preparation. In this case, the polymer P is prepared by a polymerisation reaction carried out in the presence of at least one additional monomer, different from monomers (a1) and (a2), chosen among:
*a compound (a3) of formula (II):

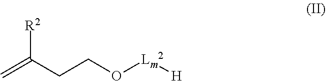

wherein:
   R² independently represents H or CH₃;
   L² independently represents an EO group or a combination of EO and PO groups;
   m independently represents an integer or decimal comprised between 10 and 150; preferably between 20 and 75;
   EO independently represents an oxyethylene group;
   PO independently represents an oxypropylene group;
*a monomer (a4) of formula (III):

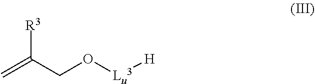

wherein:
   R³ independently represents H or CH₃;
   L³ independently represents an EO group or a combination of EO and PO groups;
   u independently represents an integer or decimal comprised between 1 and 150; preferably between 20 and 75;
   EO independently represents an oxyethylene group;
   PO independently represents an oxypropylene group;
*a monomer (a5) of formula (IV):

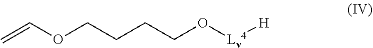

wherein:
   L⁴ independently represents an EO group or a combination of EO and PO groups;
   EO independently represents an oxyethylene group;
   PO independently represents an oxypropylene group;
   v independently represents an integer or decimal comprised between 10 and 150;
preferably between 20 and 75;
*a monomer (a6) of formula (V):

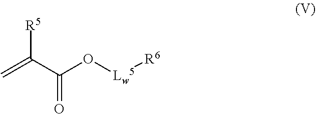

wherein:
   R⁵ and R⁶ independently represent H or CH₃;
   L⁵ independently represents an EO group or a combination of EO and PO groups;
   EO independently represents an oxyethylene group;
   PO independently represents an oxypropylene group;
   w independently represents an integer or decimal comprised between 10 and 150; preferably between 20 and 75;
*a monomer (a7) chosen among C₁-C₈ esters of an acid chosen among acrylic acid, methacrylic acid, maleic acid, crotonic acid, itaconic acid, preferably an ester chosen among methyl methacrylate, ethyl methacrylate, butyl methacrylate, 2-ethylhexyl methacrylate, methyl acrylate, ethyl acrylate, butyl acrylate, 2-ethylhexyl acrylate:
*a monomer (a8) chosen among maleic acid, maleic anhydride, itaconic acid, 2-acrylamido-2-methylpropane sulphonic acid (AMPS), vinylsulphonic acid, 2-(methacryloyloxy)-ethanesulphonic acid, methallyl sulphonic acid, styrene sulphonic acid and salts thereof, preferably itaconic acid, 2-acrylamido-2-methylpropane sulphonic acid (AMPS) and salts thereof.

According to the invention, the polymer P is prepared by at least one radical polymerisation reaction in the presence of at least one radical-generating compound. This compound can in particular be an azo compound, for example an azo compound chosen among 2,2′-azobis(2-methylpropionamidine)dihydrochloride, 2,2′-azobis(2,4-dimethylvaleronitrile), 4,4′-azobis(4-cyanovaleric) acid, AZDN or azobis(isobutyronitrile). Preferably according to the invention, the radical-generating compound is chosen among hydrogen peroxide, persulphates, in particular sodium persulphate and ammonium persulphate.

In addition to a radical-generating compound, the polymerisation reaction can also use at least one compound comprising phosphorus in the oxidation I state. Preferably, this compound is chosen among hypophosphorous acid (H₃PO₂) and a derivative of hypophosphorous acid (H₃PO₂). Even more preferably, this compound comprises at least one hypophosphite ion (H₂PO₂⁻). More preferentially, this compound is chosen among sodium hypophosphite (H₂PO₂Na), potassium hypophosphite (H₂PO₂K), calcium hypophosphite ([H₂PO₂]₂Ca) and combinations thereof. According to the invention, the polymerisation reaction can also be carried out in the presence of at least one compound comprising a bisulphite ion, preferably a compound chosen among ammonium bisulphite, an alkali metal bisulphite, in particular sodium bisulphite, potassium bisulphite, calcium bisulphite, magnesium bisulphite and combinations thereof. According to the invention, the polymerisation reaction can also be carried out in the presence of at least one compound comprising phosphorus in the oxidation III state, preferably a compound chosen among phosphorous acid and a phosphorous acid derivative. Preferentially, this compound comprises at least one phosphite ion, in particular a compound chosen among sodium phosphite, calcium phosphite, potassium phosphite, ammonium phosphite and combinations thereof. According to the invention, the polymerisation reaction can also be carried out in the presence of from 0.05 to 5% by weight, relative to the total amount of monomers, of at least one compound chosen among a xanthate derivative, a mercaptan compound and a compound of formula (F):

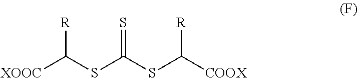

wherein:
X independently represents H, Na or K,
R independently represents a C₁-C₅-alkyl group, preferably a methyl group. Preferably according to the invention, the compound of formula (F) is disodium trithiocarbonate diisopropionate (DPTTC). According to the invention, the polymerisation reaction can also be carried out in the presence of at least one reducing compound, for example a compound chosen among hydroxylamine sulphate, hydrazine hydrate, iron (II) salts such as iron sulphate, copper (II) salts such as copper sulphate and combinations thereof.

According to the invention, the polymerisation reaction is carried out at a temperature above 50° C., in particular at a temperature ranging from 50 to 98° C. or from 75 to 99° C., and at atmospheric pressure. Preferably, the polymerisation reaction is carried out from 50 to 95° C. or from 50 to 85° C. The polymerisation reaction can also be carried out at a pressure above atmospheric pressure and at a temperature above 100° C., preferably below 140° C. According to the invention, the polymerisation reaction is carried out in water, in a solvent, alone or in a mixture with water, in particular an alcohol solvent, in particular isopropyl alcohol. Preferably, it is carried out in water.

Preferably according to the invention, the polymer P is completely or partially neutralised, in particular at the end of the polymerisation reaction. More preferentially, the polymer P is neutralised using at least one derivative chosen among an alkali metal, an alkaline-earth metal, an amine derivative, ammoniac, ammonia and combinations thereof. More preferentially, the polymer P is neutralised using a derivative comprising at least one element chosen among lithium, sodium, potassium, calcium, magnesium and combinations thereof, for example LiOH, NaOH, KOH, Ca(OH)₂, Mg(OH)₂, an amine derivative chosen among monoisopropylamine, 2-amino-2-methylpropanol (AMP), triethylamine, diethylamine, monoethylamine and combinations thereof. Sodium, calcium and combinations thereof are particularly preferred. Neutralisation with sodium and calcium can therefore be carried out using at least one compound chosen among NaOH, Ca(OH)₂ and combinations thereof. The respective proportions of sodium and of calcium can vary quite widely. For example, the Na/Ca molar ratio can range from 98/2 to 30/70, preferably from 95/5 to 40/60, more preferentially from 90/10 to 30/70 or from 90/10 to 40/60, even more preferentially from 70/30 to 40/60, particularly 50/50.

In addition to polymer P, agent A according to the invention comprises a derivative S as the second essential ingredient. Derivative S can be a non-alkoxylated derivative, a monoalkoxylated derivative or a polyalkoxylated derivative. Preferably, derivative S is an ose S1. More preferably, ose S1 is chosen among trioses (oses comprising 3 carbon atoms), tetroses (oses comprising 4 carbon atoms), pentoses (oses comprising 5 carbon atoms), hexoses and deoxyhexoses (oses comprising 6 carbon atoms), heptoses (oses comprising 7 carbon atoms), octoses (oses comprising 8 carbon atoms): preferably chosen among glyceraldehyde, dihydroxyacetone, erythrose, threose, erythrulose, 2-deoxyribose, ribose, arabinose, xylose, lyxose, ribulose, xylulose, allose, altrose, galactose, glucose, gulose, idose, mannose, talose, fructose, psicose, sorbose, tagatose, fucose, rhamnose, sedoheptulose, mannoheptulose, heptahydroxyoctanal.

Also preferably according to the invention, derivative S is an oligomer S2. Oligomer S2 is a polyholoside. Preferably, oligomer S2 is chosen among ose dimers, ose trimers, ose tetramers: preferably chosen among maltose, lactose, sucrose, maltotriose and maltotetraose. More preferentially, derivative S2 is chosen among glucose, glucose syrup, sucrose, sorbitol and combinations thereof.

According to the invention, polyol S3 is an organic compound with the general chemical formula CₙH₂ₙ₊₂Oₙ and that comprises at least two alcohol (OH) groups. Polyols S3 according to the invention are generally derivatives of oses and are obtained by reducing the aldehyde or ketone group of a carbohydrate. Polyols S3 can be classified in two groups: alditols, or aliphatic polyols, and cyclitols, or cyclic polyols. Alditols have a straight chain of carbon atoms: depending on the length of their carbon chain: alditols are referred to as triols, tetraols, pentitols, hexitols and heptitols. Some can have 9 OH groups. The cyclitols are cyclohexane derivatives. Polyols S3 can be monosaccharide polyols or disaccharide polyols. Preferably, polyol S3 is chosen among glycerol, erythritol, erythrol, xylitol, arabitol or lyxitol, ribitol or adonitol, sorbitol or gulitol, dulcitol or galactitol, mannitol, volemitol, maltitol, isomaltitol, lactitol, lactositol and combinations thereof. Preferably according to the invention, derivative S is a carboxylic or polycarboxylic acid S4. More preferably, acid S4 is chosen among gluconic acid, citric acids, lactic acid, tartaric acid, glucoheptonic acids and salts of these acids.

Advantageously, agent A according to the invention can be prepared by mixing polymer P and derivative S. Agent A can be formulated in water. However, it is also possible to use one or more organic solvents, alone or combined with water. Preferably, the polymer P and the derivative S are combined to form agent A when preparing lime milk.

Agent A according to the invention can be used when preparing lime milk or an aqueous suspension of calcium dihydroxide particles. It can come from quicklime or slaked lime. Thus, the invention also provides a method for preparing lime milk comprising the addition in an aqueous suspension of calcium dihydroxide particles (Ca(OH)₂) from at least one agent A according to the invention. When used, agent A according to the invention can be used as is. It can also be used extemporaneously or prepared in situ.

According to the invention, lime milk can be prepared by slaking calcium lime or dolomitic lime or from hydrated lime or hydrated and powdered dolomitic lime or by diluting calcium hydrate paste.

Preferably according to the invention, the hydrated lime particles have a size distribution by volume such that at least 99% of the particles have a size of less than 100 μm, preferably less than 75 μm, and at least 75% of the particles have a size greater than 1.2 μm. Also preferably according to the invention, the hydrated lime particles have a size distribution by volume such that at least 90% of the particles have a size of less than 50 μm and at least 90% of the particles have a size greater than or equal to 0.8 μm. Also preferably according to the invention, the hydrated lime particles have a size distribution by volume such that at least 90% of the particles have a size of less than 50 μm, at least 50% of the particles have a size of less than 15 μm, preferably less than 8 μm, and at least 90% of the particles have a size greater than or equal to 0.8 μm. According to the invention, the size of the lime particles or their size distribution is measured by volume using a laser diffraction granulometer. Particle size distribution (PSD) is expressed as a cumulative percentage of particles passing as a function of particle diameter and measured by laser diffraction (calculated according to the Fraunhofer or Mie theory). Distributions characterised by the terms D99 to D10 are interpolated values of the particle size distribution curve.

Agent A according to the invention makes it possible to prepare and control the stability of lime milk with a particularly high lime concentration. Preferably, the preparation method according to the invention makes it possible to prepare lime milk with a calcium dihydroxide concentration ranging from 30 to 70% by weight, more preferably from 30 to 60% by weight. More preferentially according to the invention, the concentration of lime milk prepared according to the invention ranges from 40 to 60% by weight or from 40 to 70% by weight, for example from 50% by weight. These concentrations are expressed as the dry weight of calcium dihydroxide relative to the total weight of the lime milk.

Preferably according to the invention, the preparation method is such that the lime milk comprises from 0.1 to 3% by dry weight of polymer P and from 0.1 to 3% by dry weight of derivative S, relative to the dry weight of the lime milk.

Agent A according to the invention is particularly effective for controlling the viscosity of the lime milk during its preparation but also during its storage.

Preferably according to the invention, the preparation method is such that immediately after preparation, the Brookfield viscosity of the lime milk, measured at 25° C. and at 100 rpm, is less than 300 mPa·s, preferably less than 200 mPa·s or less than 150 mPa·s. According to the invention, the Brookfield viscosity of the lime milk at 25° C. is measured using a Brookfield DV3T rheometer equipped with a spindle adapted to a speed of 100 rpm. The viscosity reading is taken after 1 minute of rotation. This rheological measurement is carried out within one hour of the preparation of the lime milk.

Also preferably according to the invention, the preparation method is such that the apparent viscosity of the lime milk according to the invention, immediately after preparation at 25° C. and at 5 s⁻¹, is less than 200 mPa·s, preferably less than 150 mPa·s or less than 100 mPa·s. Also preferably according to the invention, the preparation method is such that the apparent viscosity of the lime milk according to the invention, 10 days after preparation at 25° C. and at 5 s⁻¹, is less than 1,500 mPa·s, preferably less than 1,300 mPa·s or less than 1,000 mPa·s. According to the invention, the apparent viscosity of the lime milk, immediately after preparation and 10 days after preparation, is measured using a Thermo Scientific HAAKE RheoStress 600 rheometer coupled to a UTM Controller temperature controller and equipped with double gap geometry (CB 27 DG calibrated cylinder and CC27 DG Ti rotor) at a shear rate of 5 s⁻¹. The measurement principle is based on the introduction of the immersion rotor into a graduated cylindrical container containing the lime milk to be analysed at a temperature of 25° C. The measurement procedure includes pre-shearing at 100 s⁻¹ for 30 seconds and a rest time of 30 seconds. Measurement involves increasing and then gradually reducing the rotor speed (shear rate from 1 to 100 s⁻¹ and vice versa) to measure viscosity as a function of shear rate. The result of the viscosity measurement is obtained by averaging the viscosities corresponding to a shear rate of 5 s⁻¹ measured respectively during the rotor speed increase phase and the rotor speed decrease phase. The immediate apparent viscosity of the lime milk at 5 s⁻¹ and at 25° C. is measured within one hour of preparing the lime milk. The apparent viscosity of the lime milk after 10 days of preparation at 5 s⁻¹ and at 25° C. is measured after this lime milk has been left to age under stirring for 10 days (150 to 200 rpm) in a closed beaker to prevent evaporation.

Also preferably according to the invention, the preparation method is such that the apparent viscosity of the lime milk, immediately after preparation at 70° C. and at 20 s⁻¹, is less than 500 mPa·s, preferably less than 250 mPa·s or less than 100 mPa·s. The measurement principle is based on the introduction of the immersion rotor into a graduated cylindrical container containing the lime milk to be analysed, generally at a temperature of 25° C. When the rotor rotates in the lime milk, the latter opposes a resistance to the rotation due to its viscosity. The measurement procedure includes an increase in the rotor rotation speed followed by a gradual decrease in the rotor rotation speed to produce a viscosity hysteresis curve as a function of shear rate. The measurement procedure can be changed to include a temperature excursion for a fixed rotation speed. According to the invention, the viscosity of the lime milk at 70° C. is measured using a Thermo Scientific Haake RheoStress 600 viscometer coupled to a UTM Controller temperature controller and equipped with double gap geometry (CB 27 DG calibrated cylinder and CC27 DG Ti rotor) from 25° C. to 80° C. The measurement procedure includes pre-shearing at 1,000 s⁻¹ for 30 seconds at 25° C., a rest time at 25° C. for 30 seconds, and then measuring the viscosity of the lime milk from 25 to 80° C. at a constant shear rate (20 s⁻¹). This rheological measurement is carried out within one hour of the preparation of the lime milk. The viscosity curve of the lime milk measured at 20 s⁻¹ as a function of temperature can then be plotted to obtain the viscosity at 70° C.

Advantageously, agent A according to the invention also makes it possible to improve the stability of lime milk by controlling the settling of the lime particles in the prepared lime milk. According to the invention, the stability of the lime suspension is measured by settling, by leaving a sample of lime milk according to the invention to rest for 24 hours in a graduated 250 mL test tube at room temperature. Settling is expressed as a percentage of the supernatant (volume of supernatant water in mL after 24 hours×100/250). Advantageously, agent A makes it possible to substantially slow settling. More advantageously, agent A makes it possible to stop settling significantly, in particular during the period between the preparation of the lime milk and its use. Preferably, the method for preparing lime milk according to the invention allows for a settling rate of less than 5% of the volume of supernatant measured, more preferentially less than 3% of the volume of supernatant. According to the invention, supernatant is defined as the distinct phase of the lime milk that can form during settling, in particular after a minimum of 8 hours after the lime milk has been prepared.

The preparation method according to the invention makes it possible to confer particularly advantageous properties on the lime milk obtained. The invention therefore also relates to lime milk prepared according to the preparation method according to the invention.

Advantageously according to the invention, lime milk has particularly effective neutralising properties. Preferably according to the invention, the neutralising properties of lime milk make it possible to attain a pH value of 8 in less than 20 s, preferably in less than 15 s, to neutralise a sulphuric acid solution. Also preferably according to the invention, the neutralising properties of lime milk make it possible to attain a pH value of 10 in less than 40 s, preferably in less than 30 s, to neutralise a sulphuric acid solution. According to the invention, the neutralising properties of the suspension are measured by adding a sample of a 50% concentration of lime milk to a sulphuric acid solution and then measuring the pH as a function of time. 250 g of sulphuric acid solution (0.5 N) and 50 g of bi-permuted water are weighed into a beaker. Under stirring, lime milk at a concentration of 50% by weight is added, corresponding to 6.02 dry g of lime. As soon as the lime milk is introduced into the sulphuric acid solution (t=0), the change in the pH of the acid solution is measured as a function of time to determine the respective times necessary to attain the values of pH 8 and pH 10 (respectively tpH8 and tpH10 in seconds) after the lime milk has been introduced. According to the invention, the pH can be measured at 25° C. with a WTW pH-meter equipped with a conventional electrode coupled to a temperature probe.

Agent A according to the invention can be used when preparing lime milk with improved properties. Agent A can also be used for preparing powder or paste formulations. The invention therefore provides a method for preparing a powder formulation or a paste formulation comprising mixing at least one agent A according to the invention with calcium dihydroxide (Ca(OH)₂ or slaked lime) particles or with calcium oxide (CaO or quicklime) particles.

When preparing these powder or paste formulations, agent A can be added in solid or liquid form. Agent A can also be added by separate addition of polymer P and of derivative S.

Very advantageously according to the invention, within these powder or paste formulations, the amount of calcium dihydroxide or of calcium oxide particles can vary quite widely. Preferably for these powder or paste formulations, the amount by weight of calcium dihydroxide or of calcium oxide particles, measured according to standard method EN 459-2, § 5.8, is greater than 90%, preferably greater than 92% by weight or greater than 95% by weight, more preferentially greater than 98% by weight, relative to the weight of the formulation.

Preferably for these powder or paste formulations, the particles have a moisture content, measured at 150° C. using an infrared thermobalance, comprised between 0.2% by weight and 3% by weight, preferably between 0.3% by weight and 2% by weight, relative to the weight of the formulation.

In these powder or paste formulations, the size of the calcium dihydroxide or calcium oxide particles can vary. Preferably, these particles have a size d97 by volume, measured by laser granulometry, of less than or equal to 40 μm, preferably less than or equal to 20 μm or to 15 μm. Also preferably, these particles have a size d50 by volume, measured by laser granulometry, comprised between 2 μm and 15 μm, preferably comprised between 2 μm and 12 μm.

Advantageously, the particles of these powder or paste formulations, preferably the calcium dihydroxide particles, have a specific surface area measured by nitrogen adsorption manometry and calculated according to the Brunauer, Emmett and Teller model (BET method) after degassing for 2 hours at 190° C., comprised between 5 m²/g and 45 m²/g, preferably between 7 m²/g and 30 m²/g, more preferentially between 8 m²/g and 25 m²/g.

Very advantageously, these particles, preferably the calcium dihydroxide particles, have a fluidity, measured according to the standard ASTM D6128 method, ranging from 1.2 to 2.0 or ranging from 1.3 to 1.8.

These powder or paste formulations are also part of the invention. Thus, the invention provides a powder formulation or a paste formulation that is prepared according to the preparation method according to the invention.

These powder or paste formulations make it possible to prepare lime milk according to the invention. Thus, the invention also provides a method for preparing lime milk comprising mixing water and at least one powder formulation according to the invention or at least one paste formulation according to the invention. The lime milk thus prepared is also part of the invention.

Due to its special properties, lime milk according to the invention can be used in many situations, in particular to act on the pH of the medium in which it is used. Thus, the invention also provides a method for controlling the pH of a composition comprising contacting the composition with at least one lime milk according to the invention or with at least one powder formulation or with at least one paste formulation according to the invention. Preferably, the pH control method according to the invention is used for a composition chosen among a liquid effluent, an aqueous ore suspension, an aqueous suspension of an ore residue, an acid composition, a gaseous effluent, fumes, drinking water or water for human or animal consumption, industrial water.

According to the invention, the particular, advantageous or preferred characteristics of agent A according to the invention define lime milk or a method for its preparation or methods for its use or even powder or paste formulations as well as their preparation methods or their uses, which are also particular, advantageous or preferred.

The various aspects of the invention can be illustrated by examples.

### EXAMPLE 1: PREPARATION OF POLYMERS P ACCORDING TO THE INVENTION

### Preparation of Polymer P1 According to the Invention:

Water (220 g) is placed in a stirred reactor. The reactor is heated to 65±2° C. Then, for 3 hours, a mixture of methacrylic acid (21.58 g) and of monomer a2-1 of formula I wherein L¹ represents a methacrylate group, R¹ represents H, n represents 97 and p represents 11 and with a molecular mass of 5,000 g/mol in a 50% by weight solution in water (795.40 g), a mixture of ammonium persulphate (0.98 g) and of water (50 g) and a mixture of 1,8-dimercapto-3,6-dioxaoctane (DMDO) (1.17 g) and of monomer a2-1 with a molecular mass of 5,000 g/mol in a 50% by weight solution in water (100 g), is injected into the reactor in parallel. Next, a mixture of ammonium persulphate (0.14 g) and of water (5 g) is added in 20 min: the reactor is kept at 65° C. for 40 min. Lastly, a mixture of hydrogen peroxide in a 35% by weight aqueous solution (1.29 g) and of 50 g of water is added: the reactor is kept at 65° C. for 30 min. The product is cooled and then partially neutralised by adding a 50% by weight aqueous sodium hydroxide solution (0.5 g). The result is copolymer P1 comprising 73.7 mol % of methacrylic acid and 26.3 mol % of monomer a2-1. It has a molecular mass Mw of 300,000 g/mol and a polymolecularity index PI of 1.4. The pH of the polymer solution P1 is 3.8.

### Preparation of Polymer P2 According to the Invention:

Water (230 g) is placed in a stirred reactor. The reactor is heated to 65±2° C. Then, for 3 hours, a mixture of methacrylic acid (39.72 g) and of monomer a2-2 of formula I wherein L¹ represents a methacrylate group, R¹ represents CH₃, n represents 113 and p represents 0 and with a molecular mass of 5,000 g/mol in a 50% by weight solution in water (485.88 g), a mixture of ammonium persulphate (0.97 g) and of water (50 g) and a mixture of 1,8-dimercapto-3,6-dioxaoctane (DMDO) (1.16 g) and of monomer a2-2 with a molecular mass of 5,000 g/mol in a 50% by weight solution in water (67.54 g), is injected into the reactor in parallel. Next, a mixture of ammonium persulphate (0.13 g) and of water (5 g) is added in 20 min: the reactor is kept at 65° C. for 40 min. Lastly, a mixture of hydrogen peroxide in a 35% by weight aqueous solution (1.28 g) and of 50 g of water is added: the reactor is kept at 65° C. for 30 min. The product is cooled and then partially neutralised by adding a 50% by weight aqueous sodium hydroxide solution (0.3 g). The result is copolymer P2 comprising 80.9 mol % of methacrylic acid and 19.1 mol % of monomer a2-2. It has a molecular mass Mw of 250,000 g/mol and a polymolecularity index PI of 1.75. The pH of the polymer solution is 3.9.

### Preparation of Polymer P3 According to the Invention:

Water (230 g) is placed in a stirred reactor. The reactor is heated to 65±2° C. Then, for 3 hours, a mixture of acrylic acid (17.94 g) and of monomer a2-2 with a molecular mass of 5,000 g/mol in a 50% by weight solution in water (485.88 g), a mixture of ammonium persulphate (0.97 g) and of water (50 g) and a mixture of 1,8-dimercapto-3,6-dioxaoctane (DMDO) (1.16 g) and of monomer a2-2 with a molecular mass of 5,000 g/mol in a 50% by weight solution in water (67.54 g), is injected into the reactor in parallel. Next, a mixture of ammonium persulphate (0.13 g) and of water (5 g) is added in 20 min: the reactor is then kept at 65° C. for 40 min. Lastly, a mixture of hydrogen peroxide in a 35% by weight aqueous solution (1.28 g) and of 50 g of water is added: the reactor is kept at 65° C. for 30 min. The product is cooled and then partially neutralised by adding a 50% by weight aqueous sodium hydroxide solution (1.2 g). The result is copolymer P3 comprising 81.8 mol % of acrylic acid and 18.2 mol % of monomer a2-2. It has a molecular mass Mw of 480,000 g/mol and a polymolecularity index PI of 2.3. The pH of the polymer solution P3 is 3.7.

### Preparation of Polymer P4 According to the Invention:

Water (230 g) is placed in a stirred reactor. The reactor is heated to 65±2° C. Then, for 3 hours, a mixture of acrylic acid (17.94 g) and of monomer a2-3 of formula I wherein L¹ represents a methacrylate group, R¹ represents H, n represents 111 and p represents 5 with a molecular mass of 5,000 g/mol in a 50% by weight solution in water (518 g), a mixture of ammonium persulphate (0.97 g) and of water (50.9 g) and a mixture of 1,8-dimercapto-3,6-dioxaoctane (DMDO) (1.16 g) and of monomer a2-3 with a molecular mass of 5,000 g/mol in a 50% by weight solution in water (72 g), is injected into the reactor in parallel. Next, a mixture of ammonium persulphate (0.13 g) and of water (5 g) is added in 20 min: the reactor is then kept at 65° C. for 40 min. Lastly, a mixture of hydrogen peroxide in a 35% by weight aqueous solution (1.28 g) and of 50 g of water is added: the reactor is kept at 65° C. for 30 min. The product is cooled and then partially neutralised by adding a 50% by weight aqueous sodium hydroxide solution (0.3 g). The result is copolymer P4 comprising 80.9 mol % of acrylic acid and 19.1 mol % of monomer a2-3. It has a molecular mass Mw of 125,000 g/mol and a polymolecularity index PI of 1.5. The pH of the polymer solution P4 is 3.8.

Preparation of Agents A1, A2, A3 and A4 According to the Invention and Preparation and Characterisation of Lime Milk According to the Invention Immediately after Preparation:

The stability control agents for lime milk A1, A2, A3 and A4 are prepared separately by mixing, respectively, polymers P1 to P4 and derivative S2-1 (sucrose-product D(+) 100% powder sucrose, Chimie Plus Laboratories) in water. In 850 g of water, 4.25 g of S2-1 and 10.625 g of a 40% concentration solution in water of polymers P1, P2, P3 and P4, respectively, are successively introduced under stirring. Stirring is continued for approximately 10 minutes before introducing the lime used in the preparation of the lime milk. 850 g of lime (SuperCalco 97 Carmeuse) are added to each of the preparations of agents A1, A2, A3 and A4 under stirring. Stirring is then continued for 20 minutes before characterising each lime milk thus obtained. Its solids content is measured using a dry balance at 150° C., its Brookfield viscosity at 100 rpm at 25° C., its apparent viscosity within one hour of its preparation at 5 s⁻¹ and 25° C. and its apparent viscosity within one hour of its preparation at 20 s⁻¹ and 70° C. The results are shown in Table 1.

TABLE 1

| Agent | A1 | A2 | A3 | A4 |
|---|---|---|---|---|
| Solids content (% by weight) | 50 | 50 | 50 | 50 |
| Brookfield viscosity at 100 rpm | 82 | 79 | 111 | 120 |
| and 25° C. (mPa · s) | | | | |
| Apparent viscosity at 5 s⁻¹ | 39 | 56 | 504 | 110 |
| and 25° C. (mPas · s) | | | | |
| Apparent viscosity at 20 s⁻¹ | 323 | 70 | 420 | 59 |
| and 70° C. (mPas · s) | | | | |

The various components of the viscosity of lime milk prepared according to the invention are very well controlled by means of agents A1 to A4 according to the invention. The viscosity values obtained allow for easy handling of the lime milk and facilitate its use at both room temperature and at high temperatures.

Characterisation of Lime Milk Based on Agents A1, A2. A3 and A4 According to the Invention 24 Hours after Preparation:

In addition to rheological measurements, a settling test is also performed for lime milk prepared according to the invention. A graduated 250 mL test tube is filled with lime milk containing agents A1, A2, A3 and A4, respectively. After 24 hours of rest at room temperature, the volume of supernatant is measured. The results are shown in Table 2.

TABLE 2

| Agent | A1 | A2 | A3 | A4 |
|---|---|---|---|---|
| Supernatant (%) | 1.5 | 1.6 | 2.4 | 1.6 |

Lime milk prepared according to the invention has very low supernatant levels; they are particularly stable.

Characterisation of Lime Milk Based on Agent A1 According to the Invention 10 Days after Preparation:

Its apparent viscosity is measured again 10 days after preparation at 25° C. and at 5 s⁻¹. The results are shown in Table 3.

TABLE 3

| Agent | A1 |
|---|---|
| Apparent viscosity at 5 s⁻¹ and 25° C. (mPas · s) - after 10 days | 632 |

After 10 days, the viscosity of lime milk prepared according to the invention is very well controlled by means of agent A1 according to the invention. The viscosity value obtained allows for easy handling of the lime milk and facilitates its use after storage for 10 days.

### Use of Lime Milk According to the Invention to Control the pH of an Acid Effluent:

250 g of 0.5 N H₂SO₄ solution and 50 g of bi-permuted water are weighed in a 500 mL beaker. The mixture, in which a pH measurement electrode is placed, is stirred magnetically. Lime milk containing 6.02 g dry lime is added to this acid solution while stirring. After this addition, the pH of the solution is measured as a function of time. This measurement makes it possible to determine the times required to attain, respectively, values of pH 8 and of pH 10. The results are shown in Table 4.

TABLE 4

| Agent | A1 | A2 | A3 | A4 |
|---|---|---|---|---|
| Time pH 8 (s) | 5.7 | 12.2 | 13.1 | 5.7 |
| Time pH 10 (s) | 6.0 | 24.9 | 28.4 | 6.7 |

Lime milk prepared using agents A1 to A4 according to the invention is highly reactive. It enables the acid solution to be neutralised very quickly so as to attain values of pH 8 and of pH 10.

1. An agent A suitable for controlling stability of lime milk, the agent A comprising:
a derivative S comprising an ose S1 comprising from 3 to 8 carbon atoms, an ose oligomer or polyholoside S2 comprising from 2 to 10 ose units, a polyol S3 comprising at least three alcohol (OH) groups, and/or a hydroxylated carboxylic acid S4 optionally as in salt form;
a polymer P prepared by polymerizing a mixture comprising
(a1) an anionic monomer comprising acrylic acid, methacrylic acid, an acrylic acid salt, and/or a methacrylic acid salt; and
(a2) a monomer of formula (I):
L¹-(EO)ₙ—(PO)ₚ—R¹ (I),
wherein
L¹ is acrylate, methacrylate, acrylurethane, methacrylurethane, allyloxy, methallyloxy, and/or 3-isopentenyloxy,
R¹ is H or a methyl group,
EO is an oxyethylene group,
PO is an oxypropylene group,
n is greater than 55 and less than 300,
p is 0 or a number greater than 1 and less than 150,
p is less than n, and
a sum n+p is greater than 100 and less than 300.

2. The agent of claim 1, wherein a ratio by dry weight of the polymer P and the derivative S is in a range of from 0.03 to 20.

3. The agent of claim 1, wherein the polymer P has a molecular mass by weight Mw, measured by size exclusion chromatography, in a range of from 100,000 g/mol to 500,000 g/mol, or
wherein the polymer P has a polymolecularity index measured by SEC in a range of from 1.2 to 4.

4. The agent of claim 1,
wherein the monomer (a1) is the acrylic acid and/or the methacrylic acid, or
wherein, in the monomer (a2), L¹ is the acrylate or the methacrylate, or
wherein, in the monomer (a2), R¹ is H, or
wherein, in the monomer (a2), R¹ is a methyl group, or
wherein, in the monomer (a2), n is a number in a range of from 80 to 150, or
wherein, in the monomer (a2), p a number greater than 1 and less than or equal to 20, or
wherein, in the monomer (a2), n is a number greater than 55 and less than 150 and p represents 0, or
wherein the monomer (a2), n is a number greater than 80 and less than or equal to 150 and p is a number greater than 1 and less than or equal to 20, or
wherein the monomer (a2), the sum n+p is a number in a range of from 101 to 300.

5. The agent of claim 1, wherein the polymerizing to prepare the polymer P uses
the monomer (a1) in a range of from 60 to 90 mol %, and from
the monomer (a2) in a range of from 10 to 40 mol %,
relative to a total monomer amount.

6. The agent of claim 1, wherein mixture in the polymerizing to prepare the polymer P further comprises, in addition to the monomers (a1) and (a2):
(a3) a compound of formula (II): 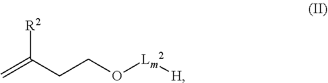
wherein:
R² is H or CH₃,
L² is independently an EO group or a combination of EO and PO groups;
m is an integer or decimal in a range of from 10 to 15,
EO is an oxyethylene group, and
PO is an oxypropylene group;
(a4) a monomer of formula (III): 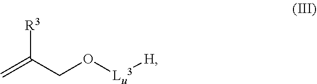
wherein;
R³ is H or CH₃,
L³ independently is an EO group or a combination of EO and PO groups,
u is an integer or decimal is in a range of from 1 to 15,
EO is an oxyethylene group, and
PO is an oxypropylene group;
(a5) a monomer of formula (IV): 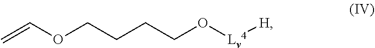
wherein:
L⁴ independently is an EO group or a combination of EO and PO groups,
EO is an oxyethylene group,
PO is an oxypropylene group, and
v is an integer or decimal in a range of from 10 to 15,
(a6) a monomer of formula (V): 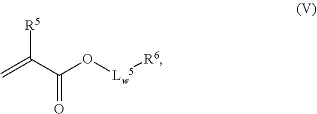
wherein:
R⁵ and R⁶ are independently H or CH₃,
L⁵ is independently an EO group or a combination of EO and PO groups,
EO is an oxyethylene group,
PO is an oxypropylene group, and
w is an integer or decimal in a range of from 10 to 15;
(a7) a monomer comprising acrylic acid, methacrylic acid, maleic acid, crotonic acid, itaconic acid, preferably an ester chosen among methyl methacrylate, ethyl methacrylate, butyl methacrylate, 2-ethylhexyl methacrylate, methyl acrylate, ethyl acrylate, butyl acrylate, and/or 2-ethylhexyl acrylate;
(a8) a monomer comprising maleic acid, maleic anhydride, itaconic acid, 2-acrylamido-2-methylpropane sulfonic acid (AMPS), vinylsulfonic acid, 2-(methacryloyloxy)ethanesulfonic acid, methallyl sulfonic acid, and/or styrene sulfonic acid, optionally in salt form.

7. The agent of claim 1, wherein the derivative S is:
an ose S1 comprising a triose (oses comprising 3 carbon atoms), tetrose (oses comprising 4 carbon atoms), pentose (oses comprising 5 carbon atoms), hexose (oses comprising 6 carbon atoms), deoxyhexose, heptose (oses comprising 7 carbon atoms), and/or octose (oses comprising 8 carbon atoms);
an oligomer S2 comprising an ose dimer, ose trimer, and/or ose tetramer;
a polyol S3 comprising glycerol, erythritol, erythrol, xylitol, arabitol or lyxitol, ribitol or adonitol, sorbitol or gulitol, dulcitol or galactitol, mannitol, volemitol, maltitol, isomaltitol, and/or lactitol or lactositol,
an acid S4 comprising gluconic acid, citric acid, lactic acid, tartaric acid, and/or glucoheptonic acid, optionally in salt form.

8. A method for preparing lime milk, the method comprising:
adding in an aqueous suspension of calcium dihydroxide particles (Ca(OH)₂) the agent A of claim 1.

9. The method of claim 8,
wherein hydrated lime particles have a size distribution by volume, measured using a laser diffraction granulometer, such that at least 99% of the particles have a size of less than 100 μm, and at least 75% of the particles have a size greater than 1.2 μm, or
wherein the hydrated lime particles have a size distribution by volume, measured using a laser diffraction granulometer, such that at least 90% of the particles have a size of less than 50 μm and at least 90% of the particles have a size greater than or equal to 0.8 μm, or
wherein the hydrated lime particles have a size distribution by volume, measured using a laser diffraction granulometer, such that at least 90% of the particles have a size of less than 50 μm, at least 50% of the particles have a size of less than 15 μm, and at least 90% of the particles have a size greater than or equal to 0.8 μm.

10. The method of claim 8, wherein the calcium dihydroxide in the lime milk has a concentration in a range of from 30 to 70 wt. %.

11. The method of claim 8, wherein the lime milk comprises, by dry weight of the lime milk:
the polymer P, by dry weight, in a range of from 0.1 to 3 wt. %; and
the derivative S, by dry weight, in a range of from 0.1 to 3 wt. %.

12. The method of claim 8,
wherein the lime milk has a Brookfield viscosity, immediately after preparation, at 25° C., at 100 rpm is less than 300 mPa·s, or
wherein the lime milk has an apparent viscosity, immediately after preparation, at 25° C., at 5 s⁻¹, is less than 200 mPa·s, or
wherein the lime milk has an apparent viscosity, immediately after preparation, at 70° C., at 20 s⁻¹, is less than 500 mPa·s, or
wherein the lime milk has an apparent viscosity, 10 days after preparation, at 25° C., at 5 s⁻¹, is less than 1,500 mPa·s,
wherein the Brookfield viscosity of the lime milk is measured using a Brookfield DV3T rheometer equipped with a spindle adapted to a speed of 100 rpm, with a viscosity reading being taken after 1 minute of rotation, and
wherein the apparent viscosity of the lime milk is measured using a Thermo Scientific HAAKE RheoStress 600 rheometer coupled to a UTM Controller temperature controller and equipped with double gap geometry, CB 27 DG calibrated cylinder, and CC27 DG Ti rotor, at a shear rate of 5 s⁻¹, using a measurement principle based on introducing an immersion rotor into a graduated cylindrical container containing the lime milk to be analyzed at a temperature of 25° C., in a measurement procedure including pre-shearing at 100 s⁻¹ for 30 seconds and a rest time of 30 seconds, followed by measurement comprising increasing and then gradually reducing the rotor speed, changing a shear rate from 1 to 100 s⁻¹ and vice versa, to measure viscosity as a function of shear rate, with a result of the measurement being obtained by averaging viscosities corresponding to a shear rate of 5 s⁻¹ measured respectively during the rotor speed increase phase and the rotor speed decrease phase.

13. The method of claim 8, wherein the lime milk has a settling rate less than 5% of a volume of supernatant measured by leaving a sample of the lime milk to rest for 24 hours in a graduated 250 mL test tube at room temperature, settling being expressed as a percentage of the supernatant by volume.

14. A lime milk, prepared by the method of claim 8.

15. The lime milk of claim 14, having neutralizing properties, measured for a sulfuric acid solution according to the method in the description, make it possible to attain a pH value of 8 in less than 20 s,
wherein the neutralizing properties are measured for a sulfuric acid solution by adding a sample of a 50% concentration of the lime milk to a sulfuric acid solution and then measuring the pH as a function of time, weighing 250 g of 0.5 N sulfuric acid solution and 50 g of bi-permuted water into a beaker, then, under stirring, adding the lime milk at a concentration of 50% by weight, corresponding to 6.02 dry g of lime, and as soon as the lime milk is introduced into the sulfuric acid solution, taken as to, a change in pH of the sulfuric acid solution is measured as a function of time to determine respective times necessary to attain pH 8 and pH 10, taken as t_{pH8} and t_{pH10} in seconds, after the lime milk has been introduced.

16. A method for preparing a powder formulation or a paste formulation, the method comprising:
mixing at least one of the agent A of claim 1 with calcium dihydroxide, Ca(OH)₂, particles or with calcium oxide, CaO, particles.

17. The method of claim 16, comprising:
adding the agent A in solid form or liquid form; or
adding the agent A by separate addition of the polymer P and of the derivative S; or
wherein the calcium dihydroxide or calcium oxide particles, measured according to standard method EN 459-2, § 5.8, is greater than 90%, relative to total powder or post formulation weight; or
wherein the calcium dihydroxide or calcium oxide particles have a moisture content, measured at 150° C. using an infrared thermobalance, in a range of from 0.2 to 3 wt. %, relative to the total powder or post formulation weight; or
wherein the calcium dihydroxide or calcium oxide particles have a size d97 by volume, measured by laser granulometry, of less than or equal to 40 μm; or
wherein the calcium dihydroxide or calcium oxide particles have a size d50 by volume, measured by laser granulometry, in a range of from 2 to 15 μm; or
wherein the calcium dihydroxide or calcium oxide particles have a specific surface area measured by nitrogen adsorption manometry and calculated according to the Brunauer, Emmett and Teller (BET) model after degassing for 2 hours at 190° C., in a range of from 5 to 45 m²/g; or
wherein the calcium dihydroxide or calcium oxide particles have a fluidity, measured according to standard ASTM D6128 method, in a range of from 1.2 to 2.0.

18. A powder formulation or a paste formulation, prepared by the method of claim 16.

19. A method for preparing lime milk, the method comprising:
mixing water and the powder or post formulation of claim 18.

20. A lime milk, prepared by the method of claim 19.

21. A method for controlling pH of a composition, the method comprising:
contacting the composition with the lime milk defined of claim 14.

22. The method of claim 21, wherein the composition is a liquid effluent, an aqueous ore suspension, an aqueous suspension of an ore residue, an acid composition, a gaseous effluent, fume, drinking water or water suitable for human or animal consumption, or industrial water.
